(19) United States
(12) Patent Application Publication
(10) Pub. No.: US 2010/0326045 A1
(43) Pub. Date: Dec. 30, 2010

(54) MULTIPLE-USE ROCKET ENGINES AND ASSOCIATED SYSTEMS AND METHODS

(75) Inventor: Gary Lai, Seattle, WA (US)

Correspondence Address: PERKINS COIE LLP;PATENT-SEA, P.O. BOX 1247, SEATTLE, WA, 98111-1247, US

(73) Assignee: Blue Origin, LLC, Kent, WA (US)

(21) Appl. No.: 12/704,690

(22) Filed: Feb. 12, 2010

Related U.S. Application Data
(60) Provisional application No. 61/152,539, filed on Feb. 13, 2009.

(51) Int. Cl. F02K 9/00; B21D 53/00; F41F 3/04; B64G 1/10

(52) U.S. Cl. 60/225; 29/890.01; 89/1.8; 244/158.5

(57) ABSTRACT

Multiple-use rocket engines and associated systems and methods are disclosed. A method in accordance with a particular embodiment includes launching a two-stage vehicle have a first stage and a second stage carried by the first stage. The first stage can be powered with a first rocket engine having first rocket engine components, including a first combustion chamber, arranged in a first component configuration. The method can further include separating the second stage from the first stage, and powering the second stage with a second rocket engine having second engine components arranged in a second component configuration. The second rocket engine components can include a second combustion chamber that is interchangeable with the first combustion chamber. In further particular embodiments, recovered engine components from the first stage may be used to power the second stage of the same or a different two-stage vehicle.

### CROSS-REFERENCE TO RELATED APPLICATION

The present application claims priority to U.S. Provisional Application No. 61/152,539, filed Feb. 13, 2009 and incorporated herein by reference.

### TECHNICAL FIELD

The present disclosure relates generally to multiple-use rocket engines and associated systems and methods.

### BACKGROUND

Rocket engines have been used for many years to launch human and non-human payloads into orbit. Such engines delivered the first humans to space and to the moon, and have launched countless satellites into the earth's orbit and beyond. Such engines are used to propel unmanned space probes and more recently to deliver structures, supplies, and personnel to the orbiting international space station.

Despite the proliferation of manned and unmanned space flights, delivering astronauts and/or cargo into space remains an expensive undertaking. A major contributor to the expense is the cost of rocket engine components, many of which are expended in order to deliver the payload. One approach to avoiding this issue is to reuse the launch vehicle. For example, NASA's space shuttle undertakes numerous missions, and after each mission, the orbiter and solid rocket boosters (SRBs) are re-used. Despite this arrangement, the shuttle remains an expensive vehicle to use. As commercial pressures for delivering both human and non-human payloads to space increase, there remains a continuing need to reduce the per-mission cost of space flight.

### BRIEF DESCRIPTION OF THE DRAWINGS

FIG. 1 is a partially schematic, isometric illustration of a multi-stage launch vehicle configured in accordance with an embodiment of the disclosure.

FIG. 2 is a schematic illustration of components for a rocket engine configured in accordance with an embodiment of the disclosure.

FIG. 3 is a partially schematic, partially cut-away illustration of the lower portion of a rocket first stage, illustrating portions of multiple engines positioned in accordance with an embodiment of the disclosure.

FIG. 4 is a partially schematic, isometric illustration of a rocket engine having re-usable components arranged in accordance with an embodiment of the disclosure.

FIG. 5 is a partially schematic, side-elevation view of a rocket engine configured for use on a first stage in accordance with an embodiment of the disclosure.

FIG. 6 is a partially schematic, side-elevation view of a rocket engine having components similar or identical to those shown in FIG. 5, and configured for upper stage use in accordance with an embodiment of the disclosure.

FIG. 7 is a flow diagram illustrating a process for manufacturing a rocket in accordance with an embodiment of the disclosure.

FIG. 8 is a flow diagram illustrating a process for using a launch vehicle in accordance with an embodiment of the disclosure.

### DETAILED DESCRIPTION

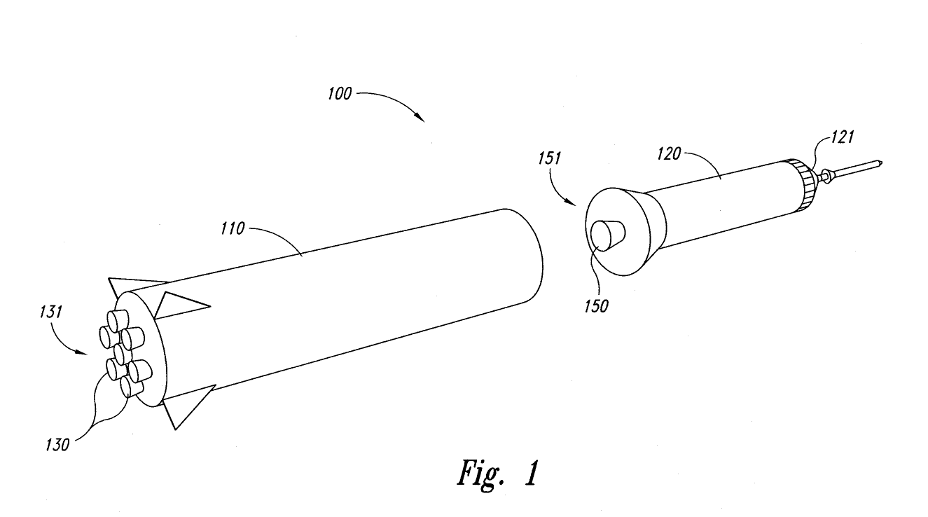

The present disclosure is directed generally to multiple-use rocket engines and associated systems and methods. Several details describing structures and processes that are well-known and often associated with such engines are not set forth in the following description for purposes of brevity. Moreover, although the following disclosure sets forth several embodiments, several other embodiments can have different configurations, arrangements, and/or components than those described in this section. In particular, other embodiments may have additional elements, or may lack one or more of the elements described below with reference to FIGS. 1-8.

FIG. 1 is a partially schematic, isometric illustration of a launch vehicle 100 configured in accordance with an embodiment of the disclosure. In one aspect of this embodiment, the launch vehicle 100 includes multiple stages, for example, two stages, which are shown in FIG. 1 as a first stage 110 and a second stage 120. In other embodiments, the launch vehicle 100 can include other multi-stage configurations, for example, a three-stage configuration. The launch vehicle 100 can be configured to deliver a payload into orbit, and/or to conduct other missions. Such missions can include suborbital missions or non-orbital missions (e.g., flight to an altitude of 350,000 feet). Accordingly, in any of these embodiments, the launch vehicle 100 includes a payload capsule 121 for carrying a human or non-human payload. The launch vehicle 100 is powered by multiple engines having common features and/or arrangements, though they may be carried by different stages. Further details of the engine arrangements are described below.

As shown in FIG. 1, the first stage 110 can include multiple first engines 130, each having a first component configuration 131. The first stage 110 can include seven first engines 130 in an embodiment illustrated in FIG. 1, and can include other numbers of engines in other embodiments. The second stage 120 can include a second engine 150 having a second component configuration 151. As will be described in further detail below, the second component configuration 151 can be entirely or at least partly the same as the first component configuration 131. Accordingly, with this level of component commonality, part or all of the first engine 130 can be functionally interchangeable with a corresponding part (or all) of the second engine 150, and vice versa. In a further aspect of this embodiment, part or all of a first engine 130 that is initially installed on the first stage 110 can be recovered and reused as a second engine 150 on the second stage 120 of the same launch vehicle 100 or a different launch vehicle 100.

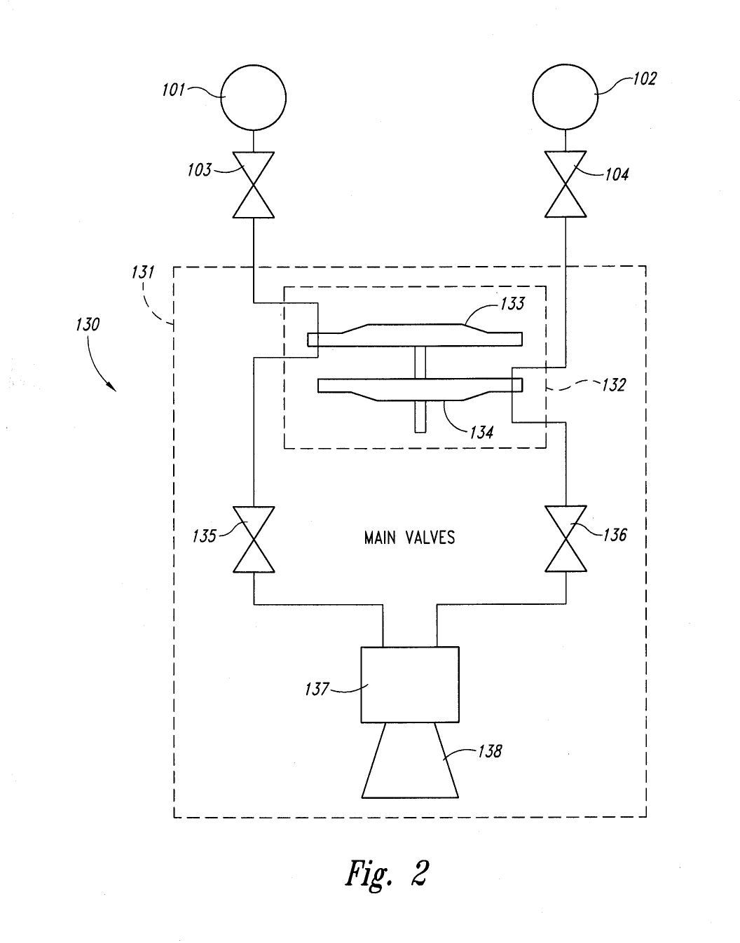

FIG. 2 is a schematic illustration of a representative first engine 130, including selected components of the first engine 130 and additional components associated with the first engine 130. The first engine 130 can include a fuel pump 133 that receives fuel from a fuel tank 101 via a fuel isolation valve 103. The fuel isolation valve 103 is closed when the first engine 130 is not operating, and is opened during engine operation. The fuel pump 133 provides fuel to a fuel valve 135 that regulates the fuel provided to a combustion chamber 137. In the combustion chamber 137, the fuel is mixed with an oxidizer, ignited, and exhausted through a nozzle 138.

The oxidizer is provided to the combustion chamber 137 from an oxidizer tank 102 via an oxidizer isolation valve 104 that provides the same isolation function for the oxidizer as the fuel isolation valve 103 provides for the fuel. The oxidizer is pumped into the combustion chamber 137 by an oxidizer pump 134 via an oxidizer valve 136 that regulates the rate at which the oxidizer enters the combustion chamber 137. The fuel pump 133 and the oxidizer pump 134 can be separate stand-alone components, or they can be driven independently or together by a common power source, e.g., a common turbo pump 132.

In one aspect of an embodiment shown in FIG. 2, selected components of the first engine 130 can form a first component configuration 131. These components can include (and in at least some embodiments, are exclusively) propulsive fluid flow components that handle (e.g., directly contact) the flow of fuel, oxidizer, and/or combustion products. For example, the first component configuration 131 can include the fuel pump 133, the oxidizer pump 134, the fuel valve 135, the oxidizer valve 136, the combustion chamber 137, and the nozzle 138. These components can be common to both the first component configuration 131 and the second component configuration 151 described above with reference to FIG. 1. Accordingly, an engine having the first component configuration 131 can be used interchangeably with an engine having the second component configuration 151. As a result, such engines may be interchangeable between the first stage 110 and the second stage 120 described above with reference to FIG. 1.

In other embodiments, the first component configuration 131 can include elements in addition to those shown in FIG. 2, or fewer elements than are shown in FIG. 2. For example, the first component configuration 131 can include the fuel isolation valve 103 and/or the oxidizer isolation valve 104 in addition to the components described above. The first component configuration 131 can also include associated control systems that control the functions of the illustrated components and/or additional components. In another embodiment, the first component configuration 131 can include fewer components in common with the second component configuration 151. For example, the common elements between the first component configuration 131 and the second component configuration 151 can include the combustion chamber 137 alone or the nozzle 138 alone, or the combustion chamber 137 and the nozzle 138.

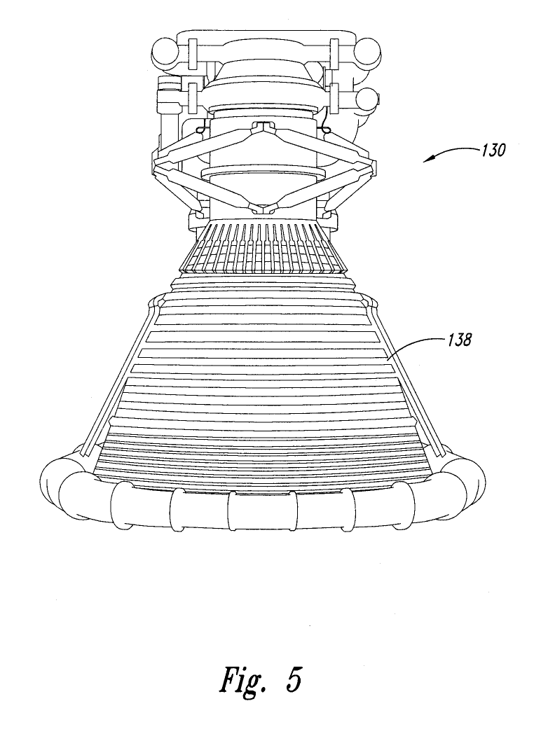

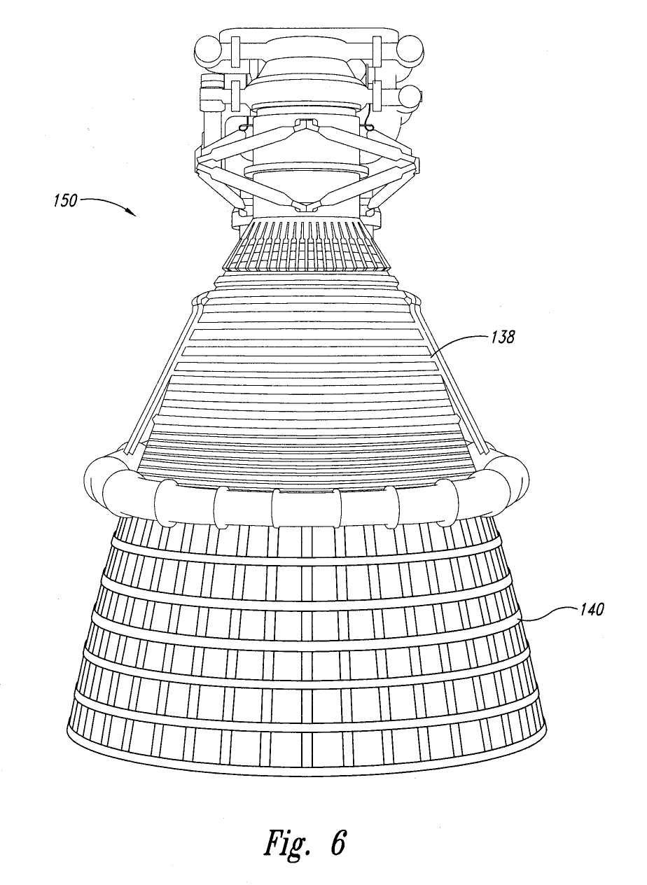

In still another embodiment, certain components shown in the first component configuration 131 may require or benefit from additional elements or structures when used in the second component configuration 151. For example, in at least one embodiment described further below with reference to FIGS. 5 and 6, the same nozzle 138 can be used with both the first component configuration 131 and the second component configuration 151 by adding structure (e.g., a nozzle skirt) to the nozzle 138 when it is used in the second component configuration 151. Accordingly, as used herein, interchangeable configurations can include a common component, or a core of common components that are useable with multiple types of rocket stages, e.g., first and second stages. Such components or component assemblies are functionally interchangeable. For example, in a particular embodiment, engines with interchangeable components arranged in interchangeable component configurations produce generally identical thrust levels when supplied with generally identical fuels and oxidizers at generally identical fuel flow conditions, and when directing exhaust products through generally identical nozzles under generally identical ambient conditions.

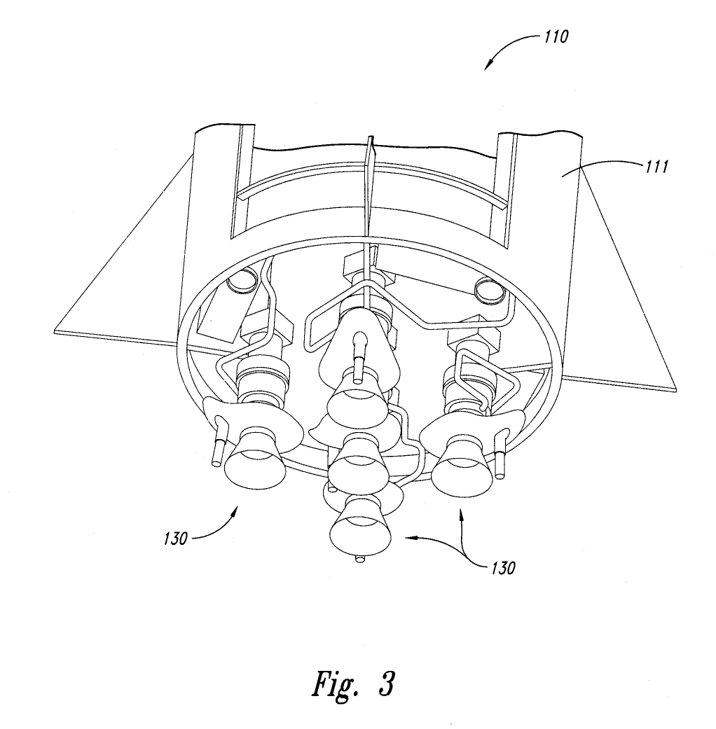

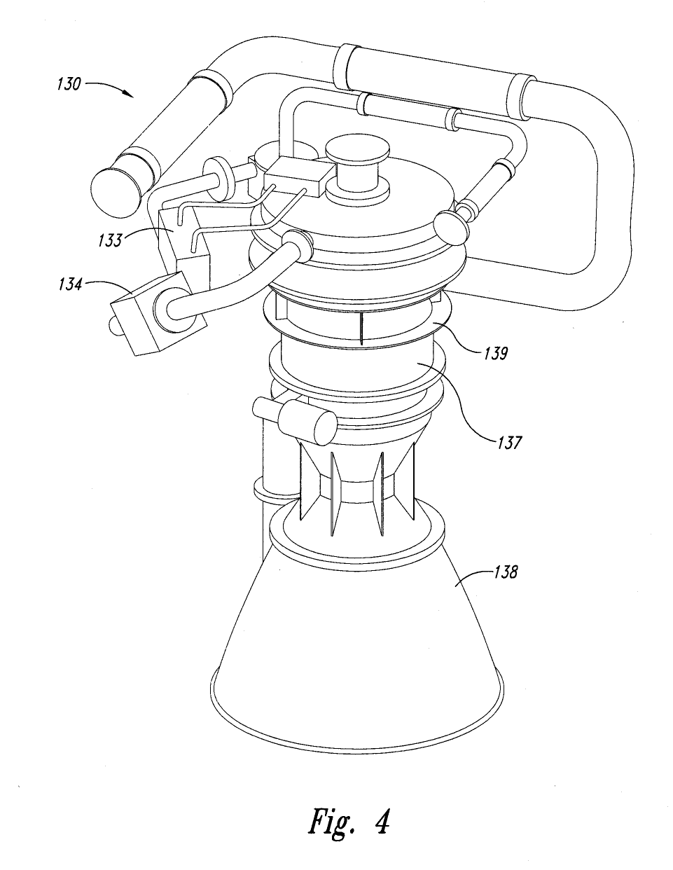

FIG. 3 is a partially schematic, partially cut-away illustration of a rocket first stage 110 having a casing 111 and first engines 130 configured in accordance with another embodiment of the disclosure. In this embodiment, the first stage 110 includes five first engines 130. The first engines 130 are supported by structure internal to the casing 111, and include propulsive fluid flow components that are described further below with reference to FIG. 4.

FIG. 4 is a partially schematic, isometric illustration of a representative first engine 130. The first engine 130 includes a fuel pump 133 and an oxidizer pump 134 that provide fuel and oxidizer, respectively, to the combustion chamber 137. A catalyst bed 139 is positioned upstream of the combustion chamber 137 to catalyze the reaction in the combustion chamber 137. The nozzle 138 receives exhaust products from the combustion chamber 137 and has a convergent-divergent configuration to accelerate the exhaust products to supersonic velocities. Suitable pumps 133, 134 are available from Pratt & Whitney Rocketdyne, Inc. of Canoga Park, Calif., and Barber-Nicols, Inc. of Arvada, Colo. The catalyst bed 139, combustion chamber 137, and nozzle 138 can be manufactured from suitable materials using suitable manufacturing processes known to those of ordinary skill in the relevant art. The fluid flow lines, conduits, and/or other fluid flow components shown in FIG. 4 can also be common to the first engine 130 and the second engine 150, so that in at least some embodiments, the entire assembly generally shown in FIG. 4 can operate on either the first stage 110 or the second stage 120 (FIG. 1).

FIG. 5 is a partially schematic, side elevation view of the first engine 130 illustrating the nozzle 138. FIG. 6 is a partially schematic, side elevation view of the second engine 150. In addition to the components described above with reference to the first engine 130, the second engine 150 can include a nozzle skirt extension 140 that further expands the exhaust products produced by the second engine 150 for operation at higher altitudes. Accordingly, the nozzle skirt extension 140 can have an exit area greater than a corresponding exit area of the baseline nozzle 138. As a result, in a particular embodiment, selected components, including the nozzle 138, are common to both the first engine 130 and the second engine 150, with the nozzle skirt extension 140 added to the second engine 150 to support its role as a second or upper stage propulsion device.

The internal flow surface contours for the baseline nozzle 138 and the extension 140 can be selected in accordance with any of several design approaches. In one approach, the internal surface contours for both the baseline nozzle 138 and the extension 140 are optimized for upper stage performance. The composite contour can be generally smooth and continuous across both the baseline nozzle 138 and the extension 140. This approach will produce a nozzle that has a peak performance level when used on the upper stage, and has a lower (though still sufficient) performance level when used on the first stage. In another approach, the composite contour can be generally continuous and optimized for first stage use, producing a nozzle that has a peak performance level when used on the first stage, and has a lower (though still sufficient) performance level when used on the upper stage. In still another approach, the composite internal contour can be selected as a compromise between a contour optimized for first stage use and a contour optimized for upper stage use. In such cases, the internal contour can have a discontinuity at the interface between the baseline nozzle 138 and the extension 140. For example, the internal surface contour of the nozzle 138 can generally emphasize performance at low altitudes, and the internal surface contour of the extension 140 can generally emphasize performance at high altitudes. The particular approach selected for designing the overall contour for the nozzle 138 and the extension 140 can be based on factors that include, but are not limited to, the relative burn times for engines in each stage, and the expected altitude ranges associated with the burn times.

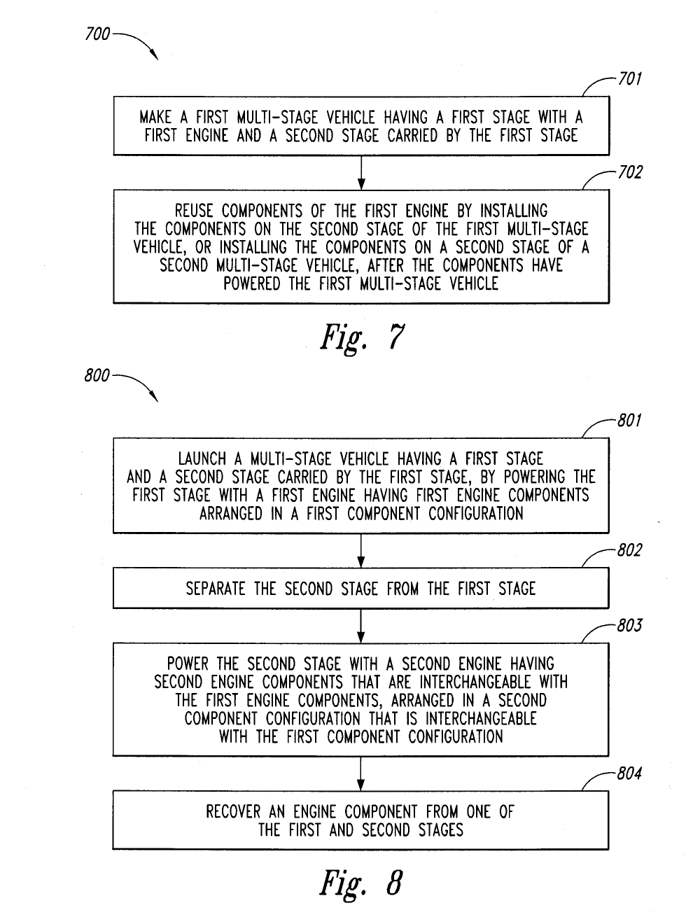

FIG. 7 is a flow diagram illustrating a process 700 for manufacturing launch vehicles. The process 700 can include making a first multi-stage vehicle (e.g., a two-stage vehicle) having a first stage with a first engine and a second stage carried by the first stage (process portion 701). The method can further include re-using one or more components of the first engine by installing the component(s) on the second stage of the first multi-stage vehicle (or installing the component(s) on the second stage of a second multi-stage vehicle), after the component(s) have powered the first multi-stage vehicle (process portion 702). Accordingly, an operator can recover the first stage 110 described above with reference to FIG. 1, remove the entire first engine 130 or a selected component or set of components of the first engine 130, and re-install the components on the second stage of the same two-stage vehicle or a different two-stage vehicle. For example, in some cases, only the first stage 110 is recovered and the second stage 120 is expended. In such cases, the recovered components are installed on the second stage of a different launch vehicle. In an embodiment in which both the first stage 110 and the second stage 120 are recovered, the re-used components can be outfitted on the second stage 120 of the same launch vehicle 100 or a different launch vehicle.

FIG. 8 is a flow diagram illustrating a process 800 for launching vehicles, and includes launching a multi-stage vehicle having a first stage and a second stage carried by the first stage, by powering the first stage with a first engine having one or more first engine components arranged in a first component configuration (process portion 801). The method can further include separating the second stage from the first stage (process portion 802) and powering the second stage with a second engine having one or more second components that are interchangeable with the first engine components (process portion 803). The second engine components can be arranged in a second component configuration that is interchangeable with the first component configuration. In process portion 804, the engine components from one or both of the first and second stages are recovered. In further particular embodiments, the recovered engine components can then be reused on a different stage of the same or a different launch vehicle.

One feature of at least some of the foregoing embodiments is that a common rocket engine type is used by two different stages of the rocket (e.g., a first stage and a second or other upper stage). Accordingly, rather than building a new engine for the upper stage of every launch vehicle, used engines from the first stage can be rotated into the upper stage. This arrangement can provide several advantages. For example, using a common rocket engine type for more than one stage of the launch vehicle can significantly reduce the cost of developing, producing, and maintaining the overall rocket system. This is so for at least the reason that common engines reduce the number of different parts required for the launch vehicle. In addition, this arrangement can potentially reduce the number of suppliers needed to manufacture the engines, and/or can reduce the inventory required to develop a fleet of launch vehicles.

Periodically removing and rotating used rocket engines from one launch vehicle stage to another can provide further advantages by reducing the per-mission cost. The following example demonstrates this effect for a launch vehicle having a reusable first stage with five engines, and an expendable upper stage having a single engine with an interchangeable component configuration. Assuming in this representative embodiment that each engine has a useful life of about ten flights, then in a conventional arrangement, after 100 flights, all five engines on the first stage will have been replaced ten times. This conventional use of the launch vehicle will require 50 engines for the first stage. In addition, one engine is expended on the upper stage during each flight, so that a total of 150 engines must be manufactured to support 100 flights. This results in an average of 1.5 engines used per flight of the launch vehicle. Conversely, in accordance with a representative embodiment of the present disclosure, only one engine is expended per flight of the same type of launch vehicle. For example, the launch vehicle can undergo five flights, expending five upper stage engines. On the sixth flight, one engine is rotated from the reusable first stage into the expendable upper stage. The open engine slot on the first stage is replaced with a new engine. Accordingly, after six flights, the launch vehicle uses a total of six engines, or one engine per flight. In this example, the resulting savings is 0.5 engines per flight, when compared to a conventional engine use schedule. Given the typical cost of rocket engines, this potential savings can be substantial.

In addition to reducing the per-mission consumption of engines, the foregoing arrangement can enhance mission reliability. In the conventional example described above, each first stage engine was replaced after flying ten times. In the foregoing example in which the engine is rotated from the first stage to the second stage after only five missions, it flies for a total of six missions before being expended. Accordingly, the likelihood for the engine to experience an age-related failure can be reduced. Still a further additional benefit of this arrangement is that rocket engines used on the second or other upper stage have already demonstrated in-flight capabilities. Therefore, the risk of these flight-demonstrated engines failing when installed on the second or other upper stage is reduced as compared with a rocket engine that has undergone only ground testing. Accordingly, in at least some embodiments, it may be advantageous to rotate each engine at or toward the middle of its expected life, so as to avoid both “infant mortality” and late life engine use.

The foregoing general methodology can be implemented in a number of different ways in accordance with particular embodiments of the disclosure. For example, one engine at a time can be rotated off the first stage, as described above. The particular engine that is rotated off the first stage can be selected based on any suitable criteria the manufacturer and/or operator establish, including but not limited to, information obtained from in-flight diagnostic sensors and/or post-flight visual inspections. The engine selected for rotation can be selected based on its ability to meet certain minimum performance standards. In addition, in some cases, the selected engine can be the available engine with the best performance.

In another representative embodiment, all five engines can be rotated off the first stage after five flights, and stockpiled for upper stage use during subsequent flights. In this and other embodiments, it is not necessary that a rotated engine be placed on the same launch vehicle that it previously powered. In still further embodiments, the general methodology can have different specific implementations, depending on such factors as the number of engines on each stage, the expected lifetime of the engines and/or specific engine components, and the nature of the expected payload (e.g., human or cargo).

From the foregoing, it will be appreciated that specific embodiments of the disclosure have been described herein for purposes of illustration, but that various modifications may be made without deviating from the disclosure. For example, the launch vehicles may include more than two stages while still benefiting from the foregoing engine rotation process. In such cases, the “second” stage can include any stage carried by the first stage. The first stage of the launch vehicle may include any number of engines, including but not limited to the five-engine and seven-engine embodiments described above. The second or other upper stage may include a single engine having at least one feature in common with the first-stage engines, or may include more than one such engine. The common feature may include a combustion chamber alone, or another single feature (e.g., a nozzle), or a set of features (e.g., a combustion chamber, nozzle, and/or other fluid flow components). The payload capsule may include a human or non-human payload. Certain aspects of the foregoing embodiments were described in the context of liquid-fueled rocket engines. Such engines can burn hydrogen or another suitable liquid propellant (e.g., RP-1, RP-2, or a hydrazine) selected based on factors that include the particular mission, payload and/or customer. In other embodiments, the rocket engines can burn solid propellants, while retaining at least some of the foregoing components common to both lower stage and upper stage engines (e.g., the nozzle and/or combustion chamber). Several of the embodiments described above were described in the context of first stage engines that are re-used on a second stage. In other embodiments, a second stage engine can be re-used on a first stage, though it is not generally expected that this arrangement will be as efficient because it necessitates recovering the second stage.

Certain aspects of the disclosure described in the context of particular embodiments may be combined or eliminated in other embodiments. Further, while advantages associated with certain embodiments have been described in the context of those embodiments, other embodiments may also exhibit such advantages. Not all embodiments need necessarily exhibit such advantages to fall within the scope of the disclosure. Accordingly, the disclosure can include other embodiments not expressly shown or described above.

I claim:

1. A launch vehicle system, comprising:
a first stage powered by a first rocket engine having first rocket engine components arranged in a first component configuration, the first rocket engine components including a first combustion chamber; and
a second stage carried by the first stage and powered by a second rocket engine, the second rocket engine having second rocket engine components arranged in a second component configuration, the second rocket engine components including a second combustion chamber that is interchangeable with the first combustion chamber.

2. The system of claim 1 wherein the first rocket engine components and the second rocket engine components are exclusively propulsive fluid flow components that directly contact a flow of fuel, oxidizer, or combustion products, and wherein the first component configuration is interchangeable with the second component configuration.

3. The system of claim 1 wherein the first rocket engine and the second rocket engine are of a common type, and wherein the second rocket engine includes at least one component not included in the first rocket engine.

4. The system of claim 1 wherein the first rocket engine includes a first nozzle having a first configuration and wherein the second rocket engine includes a second nozzle having a second configuration generally identical to the first, and wherein the second rocket engine further includes a nozzle skirt extension.

5. The system of claim 1 wherein the first rocket engine components are generally identical to corresponding second rocket engine components.

6. The system of claim 1 wherein the first rocket engine further includes a first fuel valve, a first oxidizer valve and a first nozzle, and wherein the second rocket engine includes a second fuel valve generally identical to the first fuel valve, a second oxidizer valve generally identical to the first oxidizer valve, and a second nozzle generally identical to the first nozzle.

7. The system of claim 1 wherein the first stage includes five first rocket engines and the second stage includes only a single second rocket engine.

8. The system of claim 1 wherein the first and second rocket engines produce generally identical thrust when supplied with generally identical fuels and oxidizers at generally identical flow conditions, and when directing exhaust products through generally identical nozzles under generally identical ambient conditions.

9. The system of claim 1 wherein the first rocket engine includes a first liquid fuel combustion chamber and the second rocket engine includes a second liquid fuel combustion chamber generally identical to the first.

10. The system of claim 9 wherein the first and second combustion chambers are configured to burn hydrogen.

11. The system of claim 1 wherein the second rocket engine components are components recovered from prior in-flight use with the first stage or a different first stage.

12. A method for launching vehicles, comprising:
launching a two-stage vehicle having a first stage and a second stage carried by the first stage, by powering the first stage with a first rocket engine having first rocket engine components arranged in a first component configuration, the first rocket engine components including a first combustion chamber;
separating the second stage from the first stage; and
powering the second stage with a second rocket engine having second rocket engine components arranged in a second component configuration, the second rocket engine components including a second combustion chamber that is interchangeable with the first combustion chamber.

13. The method of claim 12 wherein the first rocket engine and the second rocket engine are of a common type, and wherein powering the second stage includes powering the second stage with a second rocket engine that includes at least one component not included in the first rocket engine.

14. The method of claim 12, further comprising adding a component to the second rocket engine that is not included in the first rocket engine.

15. The method of claim 14 wherein adding a component includes adding a nozzle skirt extension to a nozzle of the second rocket engine, the nozzle of the second rocket engine being interchangeable with a nozzle of the first rocket engine.

16. The method of claim 12 wherein the first stage includes five first rocket engines and the second stage includes a single second rocket engine.

17. The method of claim 12 wherein powering the first stage includes powering the first stage with a liquid propellant having a first composition and wherein powering the second stage includes powering the second stage with a liquid propellant having a second composition that is the same as the first composition.

18. A method for launching vehicles, comprising:
launching a multi-stage vehicle having a first stage and at least a second stage carried by the first stage, by powering the first stage with a first engine;
separating the second stage from the first stage;
powering the second stage with a second engine;
recovering engine components from one of the first and second stages; and
powering the other of the first and second stages of the same or a different multi-stage vehicle with the recovered components.

19. The method of claim 18 wherein the recovered engine components are arranged in a first component configuration when installed on the one stage, and wherein the recovered engine components are arranged in a second component configuration that is interchangeable with the first component configuration when installed on the other stage.

20. The method of claim 18 wherein recovering engine components from one of the first and second stages includes recovering engine components from the first stage, and wherein powering the other of the first and second stages includes powering the second stage with the recovered components.

21. The method of claim 20 wherein the recovered components include a combustion chamber and a nozzle, and wherein the method further comprises adding a nozzle skirt to the nozzle when the nozzle is installed on the second stage.

22. The method of claim 18, further comprising removing the recovered components from service after propelling the other of the first and second stages with the recovered components.

23. The method of claim 18 wherein powering the second stage with a second engine includes propelling the second stage to a suborbital altitude.

24. The method of claim 18 wherein powering the second stage with a second rocket engine includes propelling the second stage to a suborbital altitude of 350,000 feet.

25. The method of claim 18 wherein powering the second stage includes propelling a payload to orbit with the second stage.

26. A method for launching vehicles, comprising:
launching a two-stage vehicle having a first stage and a second stage carried by the first stage, by powering the first stage with multiple first rocket engines, each having first rocket engine components arranged in a first component configuration;
separating the second stage from the first stage;
powering the second stage with a single second rocket engine having second rocket engine components that are interchangeable with the first rocket engine components, arranged in a second component configuration that is interchangeable with the first component configuration;
delivering a payload to orbit with the second stage;
recovering the first stage;
removing at least one of the first rocket engines from the first stage;
installing the removed first rocket engine on the second stage of the same or a different two-stage vehicle; and
launching the same or the different two-stage vehicle with the removed first rocket engine powering the second stage.

27. The method of claim 26 wherein the recovered first rocket engine has a combustion chamber and a nozzle having a first nozzle exit area when installed on the first stage, and wherein the recovered first rocket engine has the same combustion chamber and nozzle when installed on the second stage, and wherein the method further comprises adding a nozzle skirt to the nozzle of the recovered first rocket engine, the nozzle skirt having a second exit area greater than the first exit area.

28. The method of claim 26 wherein powering the first stage with multiple first rocket engines includes propelling the first stage with multiple first liquid fuel engines, and wherein powering the second stage with a single second rocket engine includes propelling the second stage with a single second liquid fuel engine.

29. A method for manufacturing launch vehicles, comprising:
making a first multi-stage vehicle having a first stage with a first rocket engine and a second stage carried by the first stage; and
re-using at least one component of the first rocket engine by installing the component on the second stage of the first multi-stage vehicle, or installing the component on a second stage of a second multi-stage vehicle, after the component has powered the first multi-stage vehicle.

30. The method of claim 29 wherein re-using at least one component includes re-using a combustion chamber.

31. The method of claim 29 wherein re-using at least one component includes re-using a nozzle, and wherein the method further comprises adding a nozzle skirt to the nozzle, the nozzle skirt having a greater exit area than an exit area of the nozzle.

32. The method of claim 29 wherein re-using at least one component includes re-using a fuel valve, an oxidizer valve, a combustion chamber and a nozzle.
